(19) United States
(12) Patent Application Publication
(10) Pub. No.: US 2025/0117901 A1
(43) Pub. Date: Apr. 10, 2025

(54) SIGNAL PROCESSING DEVICE, AND PROGRAM

(71) Applicant: SONY SEMICONDUCTOR SOLUTIONS CORPORATION, KANAGAWA (JP)

(72) Inventor: YUZO TAKETOMI, KANAGAWA (JP)

(21) Appl. No.: 18/834,415

(22) PCT Filed: Jan. 18, 2023
(86) PCT No.: PCT/JP2023/001342

§ 371 Date: Jul. 30, 2024

(30) Foreign Application Priority Data
Feb. 8, 2022 (JP) 2022-017967

(51) Int. Cl. G06T 5/80; H04N 23/12

(52) U.S. Cl. CPC G06T 5/80; H04N 23/12; G06T 2207/10024

(57) ABSTRACT

For signal processing to be performed on a captured image by a polarization sensor, the circuit scale of the signal processing circuit, and the size of the memory to be used in the signal processing are made smaller. A signal processing device according to the present technology includes: an image organizing unit that receives an input of a captured image obtained by a polarization sensor, and extracts a light reception value of pixels that receive light of the same polarization angle from the captured image to organize polarization-angle-specific images that are images for respective polarization angles, the polarization sensor having polarization pixel units formed by two-dimensionally arranging a plurality of types of pixels that selectively receive light of different polarization angles in a predetermined pattern, the polarization pixel units being two-dimensionally arranged in the polarization sensor; and a signal processing unit that performs signal processing on the polarization-angle-specific images obtained by the image organizing unit.

### TECHNICAL FIELD

The present technology relates to a signal processing device that performs signal processing on an image captured by a polarization sensor, and to a program.

### BACKGROUND ART

For example, as disclosed in Patent Document 1 below, a polarization sensor for obtaining a polarization image that is an image indicating polarization information for each pixel is known. With the polarization sensor, it is possible to estimate various polarization states of incident light, and it is also possible to recognize, from a polarization image, various kinds of information excluding the colors and shapes of objects, such as the orientations of the surfaces of an object (subject) and a reflected state of light.

Note that Patent Document 1 below discloses a technique for rearranging pixels to reduce noise in an image captured by the polarization sensor.

### CITATION LIST

### Patent Document

Patent Document 1: WO 2018/150683 A

### SUMMARY OF THE INVENTION

### Problems to be Solved by the Invention

Here, the polarization sensor is formed by two-dimensionally arranging a plurality of types of pixels that receive light of different polarization angles. Therefore, if signal processing for widely-used image sensors such as RGB sensors is applied to an image captured by the polarization sensor, there is a possibility that the circuit scale and the memory size will become larger.

The present technology has been made in view of the above problems, and aims to reduce the circuit scale of a signal processing circuit and the size of the memory to be used in signal processing to be performed on an image captured by a polarization sensor.

### Solutions to Problems

A first signal processing device according to the present technology includes: an image organizing unit that receives an input of a captured image obtained by a polarization sensor, and extracts the light reception value of pixels that receive light of the same polarization angle from the captured image to organize polarization-angle-specific images that are images for respective polarization angles, the polarization sensor having polarization pixel units formed by two-dimensionally arranging a plurality of types of pixels that selectively receive light of different polarization angles in a predetermined pattern, the polarization pixel units being two-dimensionally arranged in the polarization sensor; and a signal processing unit that performs signal processing on the polarization-angle-specific images obtained by the image organizing unit.

Normally, processing using an image filter is performed as signal processing on a captured image. If RAW image data is to be subjected to signal processing without organizing polarization-angle-specific images for the captured image obtained by the polarization sensor in which the polarization pixel units are two-dimensionally arranged as described above, the line buffer for holding pixel data and the image filter become larger in size, leading to an increase in the scale of the signal processing circuit and an increase in the size of the memory to be used in the signal processing. On the other hand, when the signal processing is to be performed on polarization-angle-specific images as described above, the line buffer and the image filter to be used in the signal processing can be made smaller in size.

Meanwhile, a second signal processing device according to the present technology includes: a polarization sensor in which polarization pixel units formed by two-dimensionally arranging a plurality of types of pixels that selectively receive light of different polarization angles in a predetermined pattern are two-dimensionally arranged; an image organizing unit that receives an input of a captured image obtained by the polarization sensor, extracts the light reception values of pixels that receive light of the same polarization angles from the captured image, and organizes polarization-angle-specific images that are images for the respective polarization angles; and a signal processing unit that performs signal processing on the polarization-angle-specific images obtained by the image organizing unit. That is, the second signal processing device differs from the above-described first signal processing device in including the polarization sensor as a component.

With such a second signal processing device, effects similar to those with the first signal processing device described above can be achieved.

### BRIEF DESCRIPTION OF DRAWINGS

FIG. 1 is a block diagram illustrating an example configuration of a signal processing device as a first embodiment according to the present technology.

FIG. 2 is a diagram illustrating an example configuration of a pixel array unit included in a polarization sensor in the first embodiment.

FIG. 3 is a diagram illustrating an example of a schematic cross-sectional structure of a pixel in the first embodiment.

FIG. 4 is a diagram for explaining an image organizing process by an image organizing unit and a process by a timing adjustment unit.

FIG. 5 is an explanatory diagram of a polarization state estimation process.

FIG. 6 is an explanatory diagram of a polarization image generation process.

FIG. 7 is a diagram schematically illustrating a state in a case where a filtering process is performed on a RAW image.

FIG. 8 schematically illustrates a state in a case where a filtering process is performed for each polarization-angle-specific image.

FIG. 9 is a diagram illustrating an image of lens distortion correction and pixel position correction.

FIG. 10 is an explanatory diagram of an example of a specific process in a pixel position correction process.

FIG. 11 is a diagram illustrating an example configuration of a pixel array unit included in a polarization sensor in a second embodiment.

FIG. 12 is a diagram illustrating an example of a schematic cross-sectional structure of a pixel in a polarization sensor in the second embodiment.

FIG. 13 is a block diagram illustrating an example configuration of a signal processing device as the second embodiment.

FIG. 14 is an explanatory diagram regarding an image organizing process and a demosaicing process in the second embodiment.

FIG. 15 is a block diagram illustrating an example configuration of a signal processing device as a modification.

FIG. 16 is a flowchart of processes to be performed by the signal processing unit in the modification.

### MODE FOR CARRYING OUT THE INVENTION

In the description below, embodiments according to the present technology will be described in the following order, with reference to the accompanying drawings.
<1. First Embodiment>
<2. Second Embodiment>
<3. Modifications>
<4. Summary of Embodiments>
<5. Present Technology>

### 1. First Embodiment

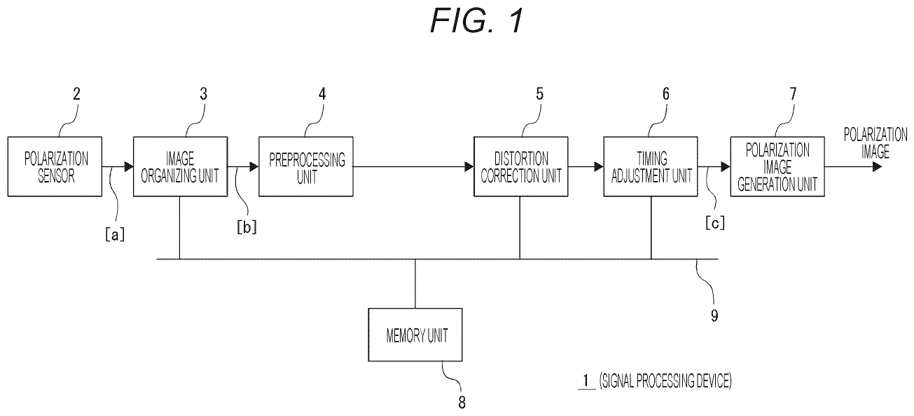

FIG. 1 is a block diagram illustrating an example configuration of a signal processing device 1 as a signal processing device as a first embodiment according to the present technology.

As illustrated, the signal processing device 1 includes a polarization sensor 2, an image organizing unit 3, a preprocessing unit 4, a distortion correction unit 5, a timing adjustment unit 6, a polarization image generation unit 7, a memory unit 8, and a bus 9. Here, the bus 9 is provided so that each of the image organizing unit 3, the distortion correction unit 5, and the timing adjustment unit 6 can read and write data from and into the memory unit 8.

The polarization sensor 2 is an image sensor for obtaining a polarization image that is an image indicating polarization information for each pixel. Note that the image sensor here means a sensor in which pixels having light receiving elements are two-dimensionally arranged.

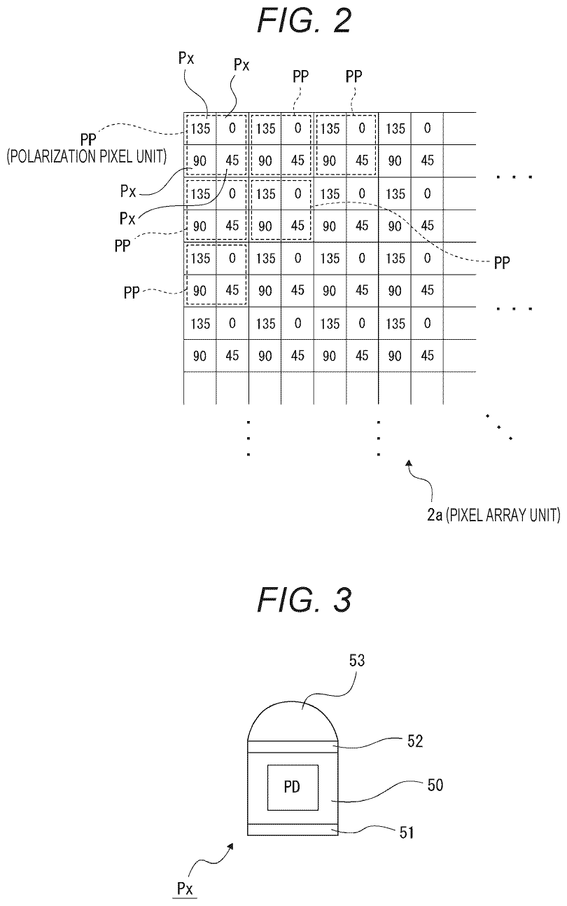

FIG. 2 is a diagram illustrating an example configuration of a pixel array unit 2a in the polarization sensor 2.

The pixel array unit 2a is formed by two-dimensionally arranging pixels Px each including a light receiving element, or specifically, a photodiode PD in this example. Specifically, in the pixel array unit 2a, a plurality of pixels Px, each of which selectively receives light having a different polarization angle, is formed. More specifically, in the pixel array unit 2a, polarization pixel units PP each having such pixels Px two-dimensionally arranged in a predetermined pattern are two-dimensionally arranged.

Each polarization pixel unit PP in this example is formed by two-dimensionally arranging, in a predetermined pattern, a total of four pixels Px: a pixel Px that selectively receives light with a polarization angle of 135 degrees; a pixel Px that selectively receives light with a polarization angle of 0 degrees (180 degrees); a pixel Px that selectively receives light with a polarization angle of 90 degrees; and a pixel Px that selectively receives light with a polarization angle of 45 degrees.

Note that the number of types of polarization angles to be selectively received by the polarization pixel units PP is determined as appropriate. Further, the pitch of the polarization angles for the respective pixels Px in each polarization pixel unit PP is not limited to the pitch of 45 degrees described above as an example, and any other appropriate pitch can be adopted.

FIG. 3 illustrates an example of a schematic cross-sectional structure of a pixel Px.

As illustrated, in a pixel Px, a photodiode PD as a light receiving element is formed in a semiconductor substrate 50, a wiring layer 51 is formed on one surface side of the semiconductor substrate 50, and a polarizing filter 52 and a microlens 53 are stacked on the other surface side of the semiconductor substrate 50.

The polarizing filter 52 includes a polarizer that selectively transmits linearly polarization light oscillating in a specific direction (at a specific angle). Examples of the polarizer include a polarizer using a wire grid, and a polarizer having a crystalline structure such as a photonic crystal.

Referring back to FIG. 1, the description continues.

The image organizing unit 3 receives an input of a captured image obtained by the polarization sensor 2, extracts the light reception value of the pixels Px that receive light of the same polarization angle from the captured image, and configures polarization-angle-specific images that are images of the respective polarization angles.

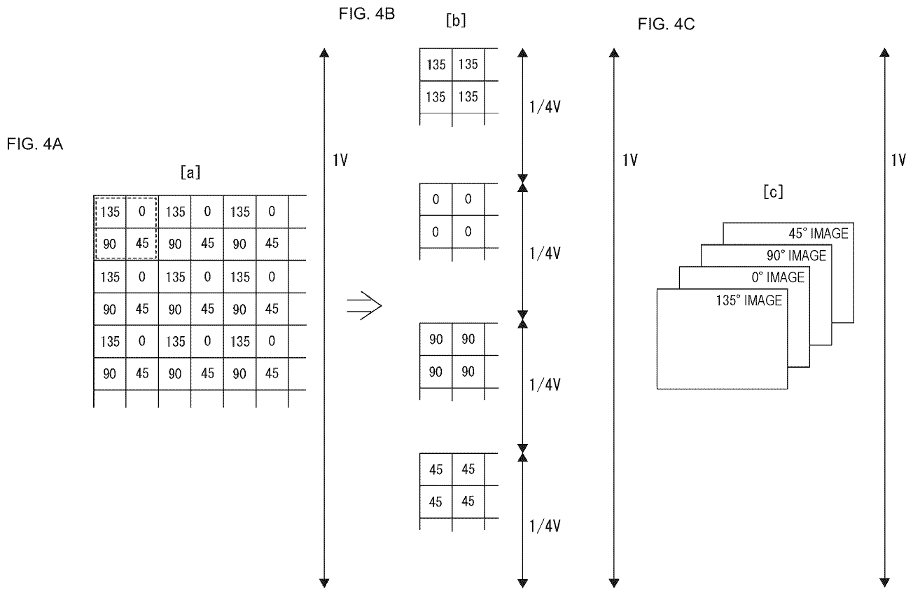

Referring now to FIG. 4, an image organizing process to be performed by the image organizing unit 3 is described.

FIG. 4A schematically illustrates a captured image (RAW image) output from the polarization sensor 2. FIG. 4B schematically illustrates polarization-angle-specific images of the respective polarization angles obtained by the image organizing process.

A RAW image of one frame is input from the polarization sensor 2 to the image organizing unit 3. The image organizing unit 3 performs the image organizing process when writing a RAW image of one frame that has been input in this manner into the memory unit 8, or when reading a written RAW image from the memory unit 8. Specifically, in this example, the following processes are performed: a process of extracting the light reception value of the pixels Px that receive light at a polarization angle of 135 degrees and generating a polarization-angle-specific image (hereinafter referred to as the “135-degree image”) including only the pixels indicating the light reception value at the polarization angle of 135 degrees; a process of extracting the light reception value of the pixels Px that receive light at a polarization angle of 0 degrees and generating a polarization-angle-specific image (hereinafter referred to as the “0-degree image”) including only the pixels indicating the light reception value at the polarization angle of 0 degrees; a process of extracting the light reception value of the pixels Px that receive light at a polarization angle of 90 degrees and generating a polarization-angle-specific image (hereinafter referred to as the “90-degree image”) including only the pixels indicating the light reception value at the polarization angle of 90 degrees; and a process of extracting the light reception value of the pixels Px that receive light of a polarization angle of 45 degrees and generating a polarization-angle-specific image (hereinafter referred to as the “45-degree image”) including only the pixels indicating the light reception value of the polarization angle of 45 degrees.

In this example, the image organizing unit 3 performs a process of organizing the 135-degree image, the 0-degree image, the 90-degree image, and the 45-degree image from a RAW image that has been input as described above in one frame period (indicated as “1 V” in FIG. 4A), without lowering throughput. That is, the 135-degree image, the 0-degree image, the 90-degree image, and the 45-degree image are output in a time-division manner within one frame period. Specifically, each polarization-angle-specific image is output for each subframe period (indicated as “¼ V” in FIG. 4B) obtained by dividing one frame period into four equal periods. For example, the 135-degree image is output in the first subframe period, the 0-degree image is output in the second subframe period, the 90-degree image is output in the third subframe period, and the 45-degree image is output in the fourth subframe period.

In FIG. 1, the preprocessing unit 4 performs image signal processing as preprocessing on each polarization-angle-specific image organized by the image organizing unit 3. Specifically, the preprocessing includes image signal processing using an image filter, such as a noise reduction process and a defect correction process.

Here, the preprocessing unit 4 in this example performs the preprocessing on the polarization-angle-specific image of each polarization angle in a time-division manner in the output order of the image organizing unit 3. Specifically, in this example, the image organizing unit 3 outputs a polarization-angle-specific image to the preprocessing unit 4 for each subframe period, but the preprocessing unit 4 sequentially processes the polarization-angle-specific images output for the respective subframe periods in this manner for the respective subframe periods, and sequentially outputs the processed images to the distortion correction unit 5 in the subsequent stage.

The distortion correction unit 5 uses the memory unit 8 to perform a lens distortion correction process on each polarization-angle-specific image output from the preprocessing unit 4.

Here, the distortion correction unit 5 in this example performs not only the lens distortion correction process but also a pixel position correction process as the signal processing for each polarization-angle-specific image, but this aspect will be described later in detail.

The timing adjustment unit 6 receives inputs of the respective polarization-angle-specific images subjected to the signal processing by the distortion correction unit 5, and performs control so that the polarization-angle-specific images are input to the polarization image generation unit 7 in a frame-synchronized manner. Specifically, in a certain frame period, the timing adjustment unit 6 causes the memory unit 8 to temporarily hold the polarization-angle-specific images that are input from the distortion correction unit 5 for the respective subframe periods. All the temporarily held polarization-angle-specific images are then output to the polarization image generation unit 7 within the frame period.

Here, to input the respective polarization-angle-specific images to the polarization image generation unit 7 in a frame-synchronized manner, it is not necessary to temporarily hold all the polarization-angle-specific images in the memory unit 8. For example, it is also possible to adopt a method by which only three polarization-angle-specific images sequentially input from the distortion correction unit 5 for the respective subframe periods are temporarily held in the memory unit 8, and all the polarization-angle-specific images are output to the polarization image generation unit 7 in response to the input of the remaining one polarization-angle-specific image in the last subframe period.

FIG. 4C illustrates an image of each polarization-angle-specific image that is input to the polarization image generation unit 7 in a frame-synchronized manner by the timing adjustment unit 6. The 135-degree image (“135° image” in the drawing), the 0-degree image (“0° image” in the drawing), the 90-degree image (“90° image” in the drawing), and the 45-degree image (“45° image” in the drawing) as the respective polarization-angle-specific images are input to the polarization image generation unit 7 in timing synchronization within one frame period.

In FIG. 1, the polarization image generation unit 7 generates a polarization image on the basis of the respective polarization-angle-specific images. The polarization image generation unit 7 performs a polarization state estimation process on the basis of the respective polarization-angle-specific images, and performs a polarization image generation process based on sine wave information indicating the polarization state of incident light obtained by the polarization state estimation process, to obtain a polarization image.

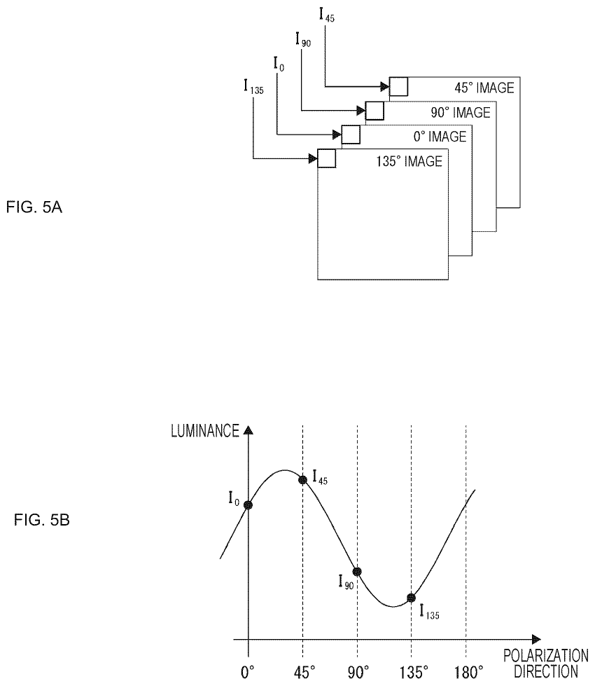

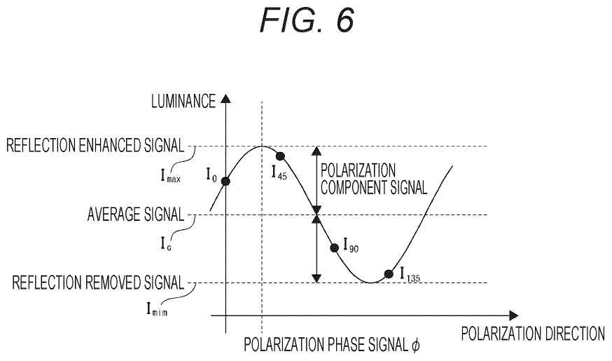

FIG. 5 is an explanatory diagram of the polarization state estimation process.

FIG. 5A schematically illustrates the 135-degree image, the 0-degree image, the 90-degree image, and the 45-degree image that are input from the timing adjustment unit 6.

In the polarization state estimation process, fitting to a sine wave as illustrated in FIG. 5B is performed for each pixel position, on the basis of the 135-degree image, the 0-degree image, the 90-degree image, and the 45-degree image.

A polarization state of incident light is expressed by a sine wave, the ordinate axis indicating luminance, the abscissa axis indicating the polarization direction (polarization angle). Accordingly, by performing fitting of a sine wave on the basis of the light reception value (luminance value) for each pixel position of each polarization-angle-specific image, the polarization state at each pixel position can be estimated.

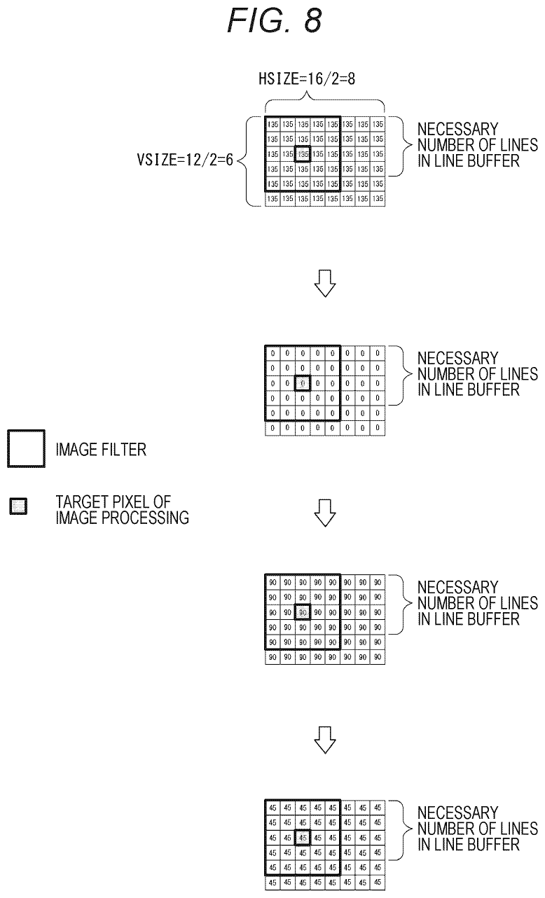

FIG. 8 is an explanatory diagram of the polarization image generation process.

By obtaining the information about the sine wave indicating the polarization state at each pixel position through the polarization state estimation process, various polarization images can be generated on the basis of the information about the sine wave.

Here, a reflection enhanced image, a polarization component image, a reflection removed image, and an average image are taken as examples of polarization images. A reflection enhanced image is an image obtained by calculating a reflection enhanced signal for each pixel position. Since the reflection enhanced signal is calculated as the maximum value (Imax) of the sine wave as illustrated in the drawing, the reflection enhanced image can be generated by calculating the maximum value of the sine wave for each pixel position.

Also, a reflection removed image is an image obtained by calculating a reflection removed signal for each pixel position. Since the reflection removed signal is calculated as the minimum value (Imin) of the sine wave as illustrated in the drawing, the reflection removed image can be generated by calculating the minimum value of the sine wave for each pixel position.

A polarization component image is an image obtained by calculating a polarization component signal for each pixel position. Since the polarization component signal is calculated as the amplitude of the sine wave as illustrated in the drawing, the polarization component image can be generated by calculating a difference value (“Imax-Ic”) between the maximum value and the average value (Ic) of the sine wave for each pixel position.

An average image is an image obtained by calculating the average signal of the sine wave for each pixel position. Accordingly, the average image can be generated by calculating the average value (Ic) of the sine wave for each pixel position.

Note that various signals each indicating a polarization state can be generated from the information about the sine wave indicating the polarization state of incident light, and the polarization images that can be generated by the polarization image generation unit 7 are not limited to the four types of images in the above example: a reflection enhanced image, a polarization component image, a reflection removed image, and an average image.

Although FIG. 1 illustrates that the polarization image generation unit 7 generates and outputs only one type of polarization image, it is needless to say that a component that generates and outputs a plurality of polarization images can be adopted.

Here, as understood from the above description, in the signal processing device 1 of the present embodiment, the image organizing unit 3 is provided to organize polarization-angle-specific images (FIG. 4B) separated for the respective polarization angles from a RAW image (FIG. 4A) captured by the polarization sensor 2, and the preprocessing unit 4 performs a filtering process such as a noise reduction process and a defect correction process on the polarization-angle-specific images.

Thus, the circuit scale of the signal processing circuit as the preprocessing unit 4 can be made smaller, and the memory size to be used for signal processing can be made smaller.

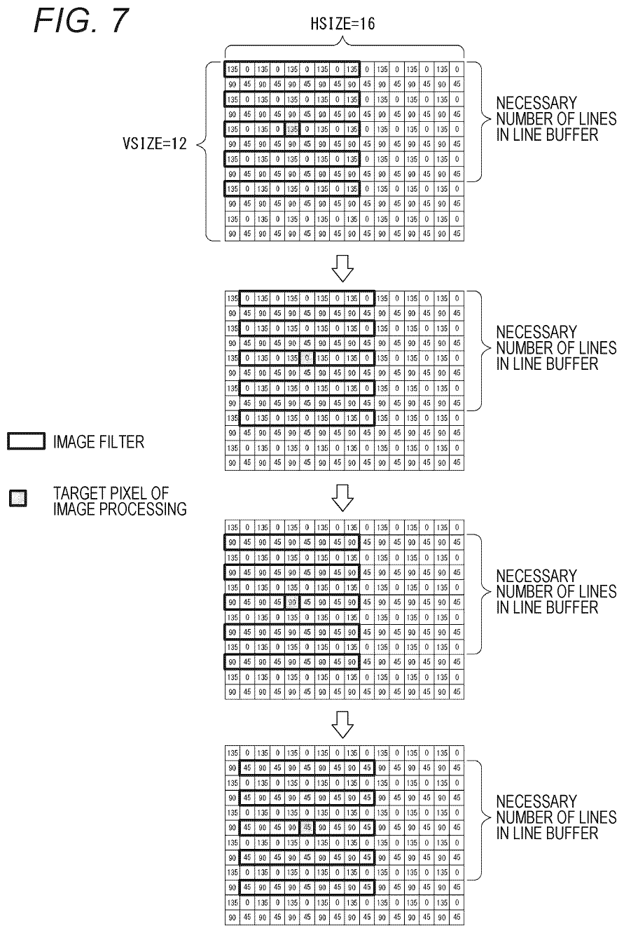

This aspect is now described with reference to FIGS. 7 and 8.

FIG. 7 schematically illustrates a state in a case where polarization-angle-specific images are not organized, and a filtering process is performed on a RAW image. In the drawing, thick-line frames represent the image filter to be used in image processing on a RAW image, and a pixel indicated in gray represents the target pixel of the image processing. Here, as a matter of course, image processing involving a correction process such as noise reduction should be performed individually for each of images of the same polarization angle.

In the RAW image, pixels that receive light at the same polarization angle are discretely arranged (or specifically, are arranged every other pixel vertically, horizontally, and diagonally). Therefore, the sizes of the line buffer and the image filter tend to become larger. Specifically, it is assumed that the image processing here is originally performed with image filter of a size of 5×5=25 pixels for each polarization angle. In the RAW image, however, pixels that receive light of the same polarization angle are discretely arranged. Therefore, if a necessary number (25 in this example) of pixels of a target polarization angle are included in an image filter, the line buffer and the filter size become larger. Even if only 25 pixels are used in the filter calculation process, a line buffer with eight lines and an image filter having a size of 9×5=45 pixels are used to hold pixel data in this example as illustrated in the drawing.

As the size of the image filter becomes larger, the circuit scale of the signal processing circuit becomes larger, and the capacity of the line buffer required for the image processing also tends to increase.

FIG. 8 schematically illustrates a state in a case where a filtering process is performed for each polarization-angle-specific image. As illustrated in the drawing, in each polarization-angle-specific image, the pixels of the same polarization angle are continuously arranged vertically, horizontally, and diagonally. Accordingly, it is possible to provide a line buffer with four lines and an image filter having an original size of 5×5=25 pixels. Thus, the circuit scale of the signal processing circuit can be made smaller, and the memory size required for the signal processing can be made smaller by reducing the necessary line buffer capacity.

Furthermore, in the signal processing device 1 of the present embodiment, the distortion correction unit 5 performs a pixel position correction process, as well as the lens distortion correction process.

Specifically, the distortion correction unit 5 performs the lens distortion correction process and the pixel position correction process as a common filtering process.

The pixel position correction process here means a process of correcting the pixel positions of the respective polarization angles that are different positions in a captured image (RAW image) obtained by the polarization sensor 2, to the same pixel position.

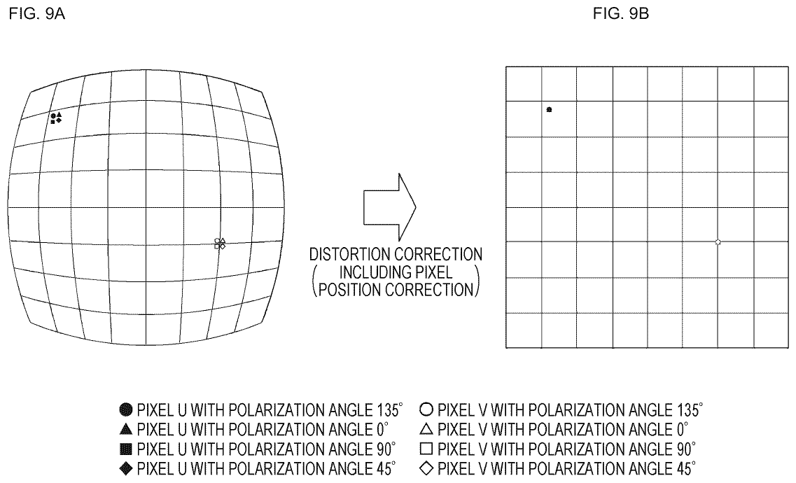

FIG. 9 is a diagram illustrating an image of lens distortion correction and pixel position correction. FIG. 9A illustrates a state before correction, and FIG. 9B illustrates a state after correction.

Regarding pixel position correction, in FIG. 9A, the pixels Px of polarization angles of 135 degrees, 0 degrees, 90 degrees, and 45 degrees in a certain polarization pixel unit PP are indicated by marks ●, ▴, ▪, and ♦, respectively, and the pixels Px of polarization angles of 135 degrees, 0 degrees, 90 degrees, and 45 degrees in another polarization pixel unit PP are indicated by marks ◯, Δ, □, and ⋄, respectively.

As illustrated as the transition from FIG. 9A to FIG. 9B, the pixel position correction is performed, so that the pixels of the respective polarization angles that are different positions before the correction are corrected to the same position in the corrected output image.

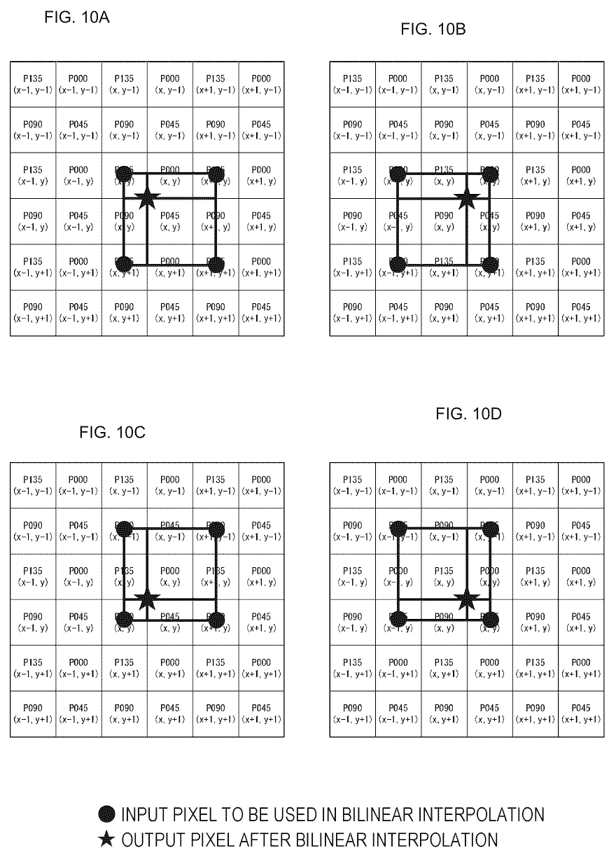

FIG. 10 is an explanatory diagram of an example of a specific process in the pixel position correction process.

As can be seen from FIG. 1 described above, in this example, the pixel position correction process by the distortion correction unit 5 is performed on the respective polarization-angle-specific images (a 135-degree image, a 0-degree image, a 90-degree image, and a 45-degree image) that are input via the preprocessing unit 4. In the pixel position correction process, a bilinear interpolation process depending on the pixel positions in an output image is performed, to obtain the light reception value (luminance value) at each pixel position.

FIGS. 10A, 10B, 10C, and 10D schematically illustrate bilinear interpolation processes for obtaining the light reception value at the same pixel position (indicated by a star in the drawings) in the output images of a 135-degree image, a 0-degree image, a 90-degree image, and a 45-degree image, respectively. Black circles in each drawing represent the input pixels to be used in the bilinear interpolation process.

The distortion correction unit 5 performs the bilinear interpolation processes for obtaining the light reception value at each pixel position in the output images, on the 135-degree image, the 0-degree image, the 90-degree image, and the 45-degree image that are input from the preprocessing unit 4.

As a result, an appropriate image in which the difference in position at each polarization angle in the RAW image is absorbed is obtained as each output image of the 135-degree image, the 0-degree image, the 90-degree image, and the 45-degree image.

Here, a certain pixel position in the output images illustrated as an example in FIG. 10 is defined as a pixel position P′ (x, y). The light reception values of the 135-degree image, the 0-degree image, the 90-degree image, and the 45-degree image to be obtained with respect to the pixel position P′ (x, y) are P′135 (x, y), P′000 (x, y), P′090 (x, y), and P′045 (x, y), respectively. The bilinear interpolation processes for obtaining P′135 (x, y), P′000 (x, y), P′090 (x, y), and P′045 (x, y) are expressed as follows.

$${P}^{′} 135 ( x , y ) = ( 3 ⋆ ( 3 ⋆ P 135 ( x , y ) + P 135 ( x , y + 1 ) ) / 4 + ( 3 ⋆ P 135 ( x + 1 , y ) + P 135 ( x + 1 , y + 1 ) ) / 4 ) / 4$$

$${P}^{′} 000 ( x , y ) = ( 3 ⋆ ( 3 ⋆ P 000 ( x , y ) + P 000 ( x , y + 1 ) ) / 4 + ( 3 ⋆ P 000 ( x − 1 , y ) + P 000 ( x − 1 , y + 1 ) ) / 4 ) / 4$$

$${P}^{′} 090 ( x , y ) = ( 3 ⋆ ( 3 ⋆ P 090 ( x , y ) + P 090 ( x , y + 1 ) ) / 4 + ( 3 ⋆ P 090 ( x − 1 , y ) + P 090 ( x − 1 , y + 1 ) ) / 4 ) / 4$$

$${P}^{′} 045 ( x , y ) = ( 3 ⋆ ( 3 ⋆ P 045 ( x , y ) + P 045 ( x , y + 1 ) ) / 4 + ( 3 ⋆ P 045 ( x − 1 , y ) + P 045 ( x − 1 , y + 1 ) ) / 4 ) / 4$$

Note that the bilinear interpolation process may be modified from the above expressions, to reduce the circuit scale or the like.

As described above, each bilinear interpolation process is a kind of a filtering process that is performed with light reception values at a plurality of input pixel positions. Specifically, a filter calculation process is performed with the light reception values at a plurality of input pixel positions and a predetermined weight coefficient.

Here, as described above, the distortion correction unit 5 performs the pixel position correction process and the lens distortion correction process as a common filtering process. Specifically, the distortion correction unit 5 performs bilinear interpolation processes using not a coefficient for performing only pixel position correction but a coefficient determined so as to perform both pixel position correction and lens distortion correction, as the weight coefficient in the bilinear interpolation processes as described above.

As the pixel position correction process and the lens distortion correction process are performed as a common filtering process in this manner, it is not necessary to perform the pixel position correction process separately from the lens distortion correction process. Thus, it is possible to increase the correction process accuracy by reducing the number of times a process requiring pixel interpolation is to be performed.

Note that the filtering processes for image correction to be performed by the distortion correction unit 5 is not necessarily bilinear interpolation processes, but may be some other filtering processes such as bicubic interpolation processes, for example.

### 2. Second Embodiment

Next, a second embodiment is described.

In the first embodiment, the monochrome polarization sensor 2 is used as an example. In the second embodiment, however, a color-compatible polarization sensor 2A capable of obtaining a color image is used.

Note that, in the description below, portions similar to the portions already described are denoted by the same reference signs as above, and explanation thereof is not made herein.

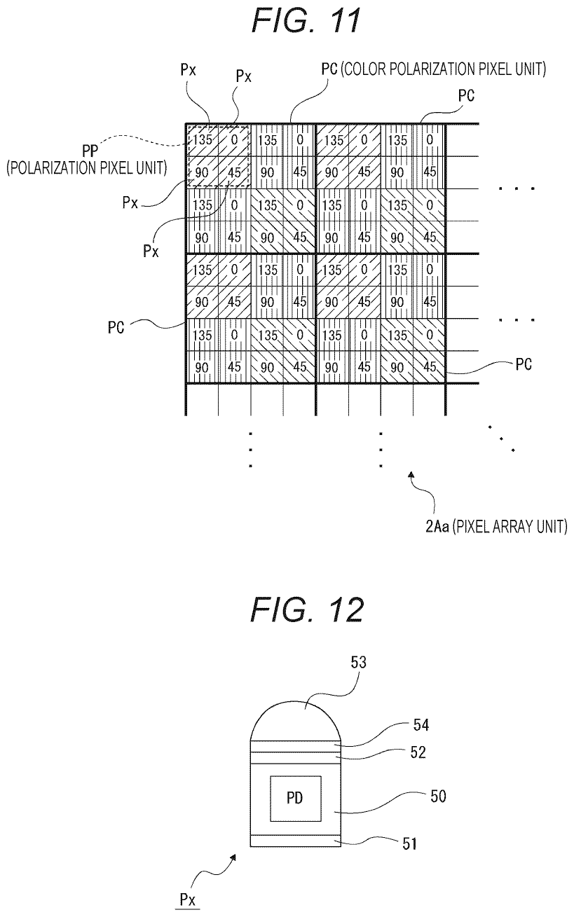

FIG. 11 is a diagram illustrating an example configuration of a pixel array unit 2Aa in the polarization sensor 2A.

As illustrated in the drawing, the pixel array unit 2Aa includes color polarization pixel units PC, in each of which a plurality of polarization pixel units PP is two-dimensionally arranged.

A color polarization pixel unit PC is a pixel unit in which a plurality of types of polarization pixel units PP that selectively receive light of colors different from one another is two-dimensionally arranged in a predetermined pattern.

Specifically, in a color polarization pixel unit PC in this example, a total of four polarization pixel units PP that are a polarization pixel unit PP that receives only R light (red light), two polarization pixel units PP that receive only G light (green light), and a polarization pixel unit PP that receives only B light (blue light) are two-dimensionally arranged in a predetermined pattern.

In the drawing, left-downward oblique lines are given to the polarization pixel units PP that selectively receive R light, vertical lines are given to the polarization pixel units PP that selectively receive G light, and right-downward oblique lines are given to the polarization pixel units PP that selectively receive B light.

In each color polarization pixel unit PC of this example, four polarization pixel units PP that receive R light, B light, and G light are arranged in a Bayer pattern.

The pixel array unit 2Aa is formed by two-dimensionally arranging the color polarization pixel units PC as described above. That is, a plurality of color polarization pixel units PC is arranged in the vertical direction (column direction) and the horizontal direction (row direction).

With the configuration of the pixel array unit 2Aa as described above, color images of R, G, and B can be generated as various polarization images. That is, color images can be generated as various polarization images.

In the pixel array unit 2Aa, each pixel Px is designed to be capable of selectively receiving light with a predetermined polarization angle, and selectively receiving light in a predetermined color (wavelength band).

FIG. 12 illustrates an example of a schematic cross-sectional structure of a pixel Px in the polarization sensor 2A.

As illustrated, in a pixel Px in this case, a color filter 54 is inserted between the polarizing filter 52 and the microlens 53. The color filter 54 is designed as an optical bandpass filter that selectively transmits light of a predetermined wavelength band. For example, in a pixel Px that receives R light, an optical bandpass filter that selectively transmits R light is formed as the color filter 54. Further, in a pixel Px that receives G light and a pixel Px that receives B light, an optical bandpass filter that selectively transmits G light and an optical bandpass filter that selectively transmits B light are formed, respectively, as the color filters 54.

Note that the vertical positional relationship between the polarizing filter 52 and the color filter 54 may be reversed.

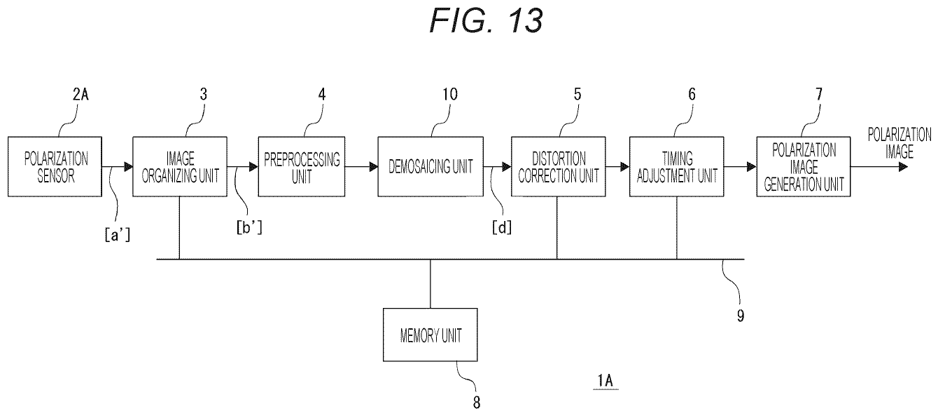

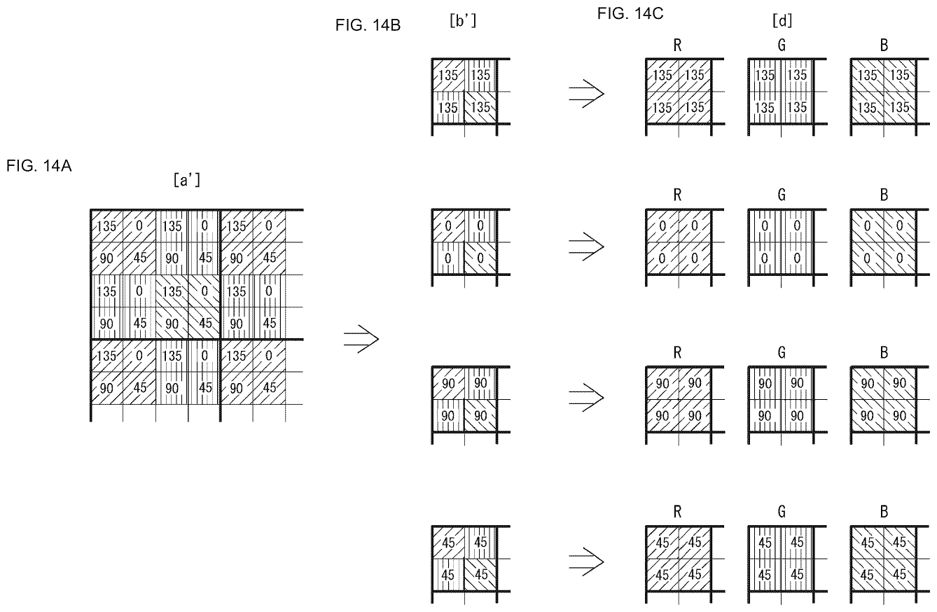

FIG. 13 is a block diagram illustrating an example of the internal configuration of a signal processing device 1A as the second embodiment that includes the polarization sensor 2A having the pixel array unit 2Aa as described above.

As can be seen from a comparison with FIG. 1 described earlier, the signal processing device 1A differs from the signal processing device 1 in that the polarization sensor 2 is replaced with the polarization sensor 2A, and a demosaicing unit 10 is added.

As illustrated, the demosaicing unit 10 is provided between the preprocessing unit 4 and the distortion correction unit 5.

Here, the image organizing unit 3 in this case performs an image organizing process on an image captured by the polarization sensor 2A, and this process is illustrated as a transition from FIG. 14A to FIG. 14B. FIG. 14A is a RAW image as a captured image output by the polarization sensor 2A. FIG. 14B is polarization-angle-specific images obtained by the image organizing process.

In this case, the image organizing process is also a process of receiving an input of a captured image from the sensor, extracting the light reception value of the pixels Px receiving light of the same polarization angle from the captured image, and organizing polarization-angle-specific images for the respective polarization angles. As illustrated in FIG. 14B, in the respective polarization-angle-specific images in this case, images in which pixels receiving light of different colors are arranged in a predetermined pattern are obtained. Specifically, in each color polarization pixel unit PC in this example, the polarization pixel units PP are arranged in the Bayer pattern. Accordingly, an image in which R, G, and B pixels are arranged in the Bayer pattern is obtained as each polarization-angle-specific image.

The demosaicing unit 10 performs a demosaicing process on each polarization-angle-specific image in which R, G, and B pixels are arranged in the Bayer array as described above. Thus, the demosaicing unit 10 can perform a demosaicing process compatible with a general Bayer array.

FIG. 14C illustrates the polarization-angle-specific images after the demosaicing process by the demosaicing unit 10.

As illustrated in the drawing, color images of R, G, and B are obtained as the respective polarization-angle-specific images of the 135-degree image, the 0-degree image, the 90-degree image, and the 45-degree image through the demosaicing process.

Here, the polarization-angle-specific images illustrated in FIG. 14B are input from the preprocessing unit 4 to the demosaicing unit 10 in the respective subframe periods. Therefore, the demosaicing unit 10 also performs the demosaicing process on the polarization-angle-specific images in the respective subframe periods.

The distortion correction unit 5 in this case processes and outputs, within the respective subframe periods, the three polarization-angle-specific images of R, G, and B that are input from the demosaicing unit 10 in the respective subframe periods.

In this case, the three polarization-angle-specific images of R, G, and B are input from the distortion correction unit 5 to the timing adjustment unit 6 in the respective subframe periods. The timing adjustment unit 6 in this case performs control so that R, G, and B polarization-angle-specific images of the respective polarization angles, which are a total of twelve polarization-angle-specific images, are input to the polarization image generation unit 7 in a frame-synchronized manner.

Note that, in the second embodiment, an example in which the polarization pixel units PP are arranged in a Bayer pattern has been described as the color-compatible polarization sensor 2A. However, in the color polarization pixel units PC, the polarization pixel units PP of the respective colors are not necessarily arranged in the Bayer pattern, but may be arranged in a predetermined pattern on which a demosaicing process can be performed.

### 4. Modifications

Although signal processing devices as embodiments have been described so far through two specific examples, signal processing devices as embodiments are not limited to the specific examples described above, and various configurations as modifications may be adopted.

For example, in the above description, examples in which processes as embodiments are performed as hardware processes have been explained. However, a process as an embodiment can also be performed as a software process. In the case of implementation of a software process, the advantages do not lie in a reduction of the circuit scale of a signal processing circuit and a reduction of the size of the memory to be used in signal processing, but in that signal processing for general monochrome sensors or RGB sensors can be adopted even in a case where a polarization sensor is used.

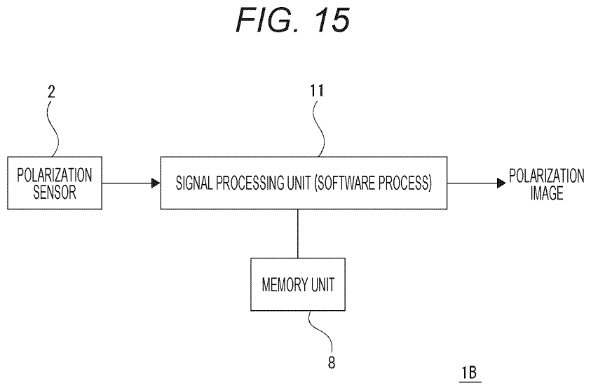

For example, as in a signal processing device 1B as a modification illustrated in FIG. 15, a signal processing unit 11 that performs a process as an embodiment through a software process, on the basis of an image captured by a polarization sensor 2 is included. The signal processing unit 11 is designed as a computer device such as a microcomputer that includes a central processing unit (CPU), a read only memory (ROM), and a random access memory (RAM), for example.

Specifically, the signal processing unit 11 in this example performs processes from the process by the image organizing unit 3 to the process by the polarization image generation unit 7 described above, as a software process. In this case, the signal processing unit 11 is designed to be capable of reading and writing data from and into the memory unit 8, and performs an image organizing process using the memory unit 8.

Note that, in a case where the color-compatible polarization sensor 2A is used, the signal processing unit 11 also performs the process that is performed by the demosaicing unit 10 in the above example.

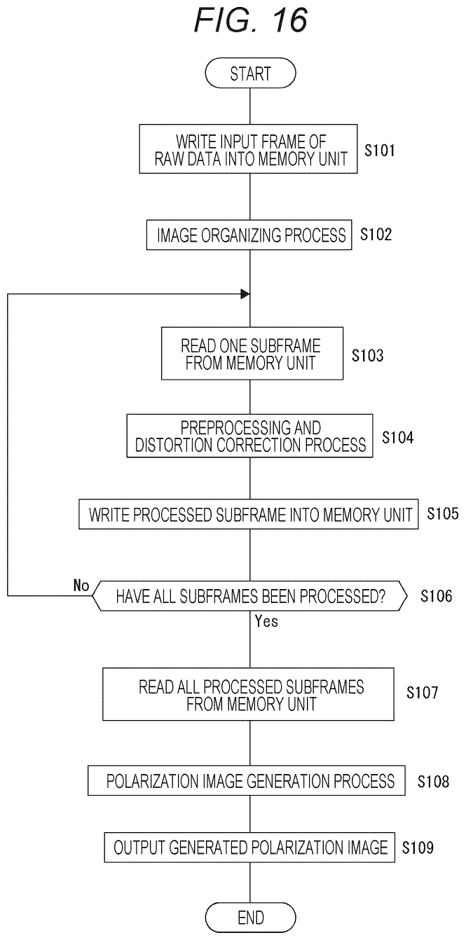

FIG. 16 is a flowchart of processes to be performed by the signal processing unit 11.

Specifically, the processes are to be performed by the CPU of the signal processing unit 11 in accordance with a program stored in the ROM or the like.

First, in step S101, the signal processing unit 11 writes RAW data, which is an input frame of an image captured by the polarization sensor 2, into the memory unit 8. In the subsequent step S102, the signal processing unit 11 then performs an image organizing process. That is, the input frame is read from the memory unit 8, and each polarization-angle-specific image (subframe) is written into the memory unit 8, which corresponds to the process to be performed by the image organizing unit 3.

In step S103 following step S102, the signal processing unit 11 reads one subframe, or one polarization-angle-specific image, from the memory unit 8, performs preprocessing and a distortion correction process in subsequent step S104, and writes the processed subframe into the memory unit 8 in step S105. Here, in the distortion correction process in step S104, a pixel position correction process is performed together with a lens distortion correction process. Specifically, in this example, the lens distortion correction process and the pixel position correction process are performed as a common filtering process.

In step S106 following step S105, the signal processing unit 11 determines whether or not the processing of all the subframes has been completed. That is, a check is made to determine whether or not the processes in steps S103 to S105 have been performed for all the organized polarization-angle-specific images.

If it is determined that the processing of all the subframes has not been completed, the signal processing unit 11 returns the process to step S103.

If it is determined that the processing of all the subframes has been completed, the signal processing unit 11 moves on to step S107 to read all the processed subframes from the memory unit 8, and performs a polarization image generation process in the step S108 that follows. That is, the above-described polarization state estimation process is performed on the basis of each polarization-angle-specific image, and a process of generating a polarization image on the basis of information about the sine wave obtained in the polarization state estimation process is performed.

In step S109 following step S108, the signal processing unit 11 performs a process of outputting the generated polarization image, and ends the series of processes illustrated in FIG. 16.

Here, as the present technology, an invention of a program for realizing the above-described processes by the signal processing unit 11 can be considered.

That is, the program as an embodiment is a program that can be read by a computer device, and causes the computer device to execute a function of: receiving an input of a captured image obtained by a polarization sensor in which polarization pixel units formed by two-dimensionally arranging a plurality of types of pixels selectively receiving light of different polarization angles in a predetermined pattern are two-dimensionally arranged; extracting the light reception value of pixels receiving light of the same polarization angle from the captured image to organize polarization-angle-specific images that are images for the respective polarization angles; and performing signal processing on the polarization-angle-specific images.

Such a program can be stored beforehand in a storage medium that can be read by a computer device, such as a ROM, a hard disk drive (HDD), or a solid state drive (SSD), for example. Alternatively, the program can be temporarily or permanently stored in a removable storage medium such as a semiconductor memory, a memory card, an optical disk, a magneto-optical disk, or a magnetic disk. Such a removable storage medium can be provided as so-called packaged software.

Furthermore, such a program can be installed from a removable storage medium into a personal computer or the like, or can be downloaded from a download site into a required information processing device such as a smartphone via a network such as a LAN or the Internet.

Note that, although a device form including a polarization sensor has been exemplified as the device form of a signal processing device in the above description, the device form of a signal processing device may not include a polarization sensor.

### 4. Summary of Embodiments

As described above, a first signal processing device (1, 1A, 1B) as an embodiment includes: an image organizing unit (3 or part of the signal processing unit 11) that receives an input of a captured image obtained by a polarization sensor (2, 2A) in which polarization pixel units (PP) each formed by two-dimensionally arranging a plurality of types of pixels selectively receiving light of different polarization angles in a predetermined pattern are two-dimensionally arranged, extracts the light reception value of pixels receiving light of the same polarization angle from the captured image, and organizes polarization-angle-specific images that are images for the respective polarization angles; and a signal processing unit (the preprocessing unit 4, the distortion correction unit 5, the demosaicing unit 10, or part of the signal processing unit 11) that performs signal processing on the polarization-angle-specific images obtained by the image organizing unit.

Normally, processing using an image filter is performed as signal processing on a captured image. If RAW image data is to be subjected to signal processing by hardware without organizing polarization-angle-specific images for the captured image obtained by the polarization sensor in which the polarization pixel units are two-dimensionally arranged as described above, the line buffer and the image filter become larger in size, leading to an increase in the scale of the signal processing circuit and an increase in the size of the memory to be used in the signal processing. On the other hand, when the signal processing is performed on polarization-angle-specific images as described above, the circuit scale of the signal processing circuit and the size of the memory to be used in the signal processing can be made smaller.

Furthermore, if RAW image data is to be subjected to signal processing by software without organizing polarization-angle-specific images, it is necessary to adopt dedicated signal processing compatible with the pixel array of the polarization sensor. On the other hand, when signal processing is performed on polarization-angle-specific images as described above, there is an advantage that signal processing (software signal processing) for general monochrome sensors or RGB sensors can be adopted even in a case where a polarization sensor is used.

Further, in the first signal processing device as an embodiment, the image organizing unit outputs the polarization-angle-specific images for the respective polarization angles in time-division manner within one frame period.

Thus, it is possible to prevent a decrease in throughput after the processing by the image organizing unit with respect to inputs of captured images of the respective frames from the polarization sensor.

Further, in the first signal processing device as an embodiment, the signal processing unit performs signal processing on the polarization-angle-specific images for the respective polarization angles in the order of outputs from the image organizing unit.

Thus, it is possible to prevent a decrease in throughput after the processing by the signal processing unit with respect to inputs of captured images of the respective frames from the polarization sensor.

Furthermore, in the first signal processing device as an embodiment, the signal processing unit performs a pixel position correction process that is a process of correcting the pixel positions with the respective polarization angles that are different positions in a captured image, to the same pixel position.

By performing the pixel position correction process as described above, polarization information relating to the original positions can be correctly obtained, and the detection accuracy of the polarization information can be increased.

Furthermore, in the first signal processing device as an embodiment, the signal processing unit performs the pixel position correction process and a lens distortion correction process as a common filtering process in the signal processing on polarization-angle-specific images.

As a result, the need to perform the pixel position correction process separately from the lens distortion correction process is eliminated, and thus, it is possible to increase the correction process accuracy by reducing the number of times a process that requires pixel interpolation is performed.

Furthermore, in a case where the correction process is performed as a hardware process, the need to provide a signal processing circuit that performs the pixel position correction process separately from a signal processing circuit that performs the lens distortion correction process is eliminated, and thus, it is possible to lower costs by making the circuit scale smaller and reducing the number of components.

Further, the first signal processing device as an embodiment includes a polarization image generation unit (7) that generates a polarization image, and a timing adjustment unit (6) that performs control so that polarization-angle-specific images subjected to signal processing by the signal processing unit are input to the polarization image generation unit in a frame-synchronized manner.

The polarization image generation unit obtains the polarization information for each pixel position, using the information relating to each polarization angle.

Thus, as the polarization-angle-specific images are input to the polarization image generation unit in a frame-synchronized manner as described above, a polarization image can be appropriately generated.

Furthermore, in the first signal processing device as an embodiment, the image organizing unit inputs a captured image obtained by a polarization sensor (2A) in which color polarization pixel units (PC) formed by two-dimensionally arranging a plurality of types of polarization pixel units that receive light of different colors in a predetermined pattern are two-dimensionally arranged, and extracts the light reception value of pixels that receive light of the same polarization angle from the captured image, to organize each polarization-angle-specific image.

In a case where the image organizing unit generates polarization-angle-specific images for a captured image obtained by the polarization sensor in which the color polarization pixel units are two-dimensionally arranged as described above, images in which pixels receiving light of different colors are arranged in a predetermined pattern can be obtained as the polarization-angle-specific images. For example, in a case where polarization pixel units are arranged in a Bayer pattern in each color polarization pixel unit, it is possible to obtain an image in the Bayer array as each polarization-angle-specific image.

Accordingly, in a case where a demosaicing process is performed on these polarization-angle-specific images, it is possible to use a general demosaicing process, and the need to develop a dedicated demosaicing process can be eliminated. Thus, the costs of development of the signal processing system for polarization images can be lowered.

Further, in the first signal processing device as an embodiment, in the polarization sensor, a color polarization pixel unit is formed with a polarization pixel unit that selectively receives red light, a polarization pixel unit that selectively receives green light, and a polarization pixel unit that selectively receives blue light, which are arranged in a Bayer pattern.

As a result, it is possible to adopt a demosaicing process compatible with the Bayer array that is used in demosaicing of RGB images, as the demosaicing process for the polarization-angle-specific images.

Thus, the need to develop a dedicated demosaicing process can be eliminated, and the costs of development of the signal processing system for polarization images can be lowered.

Further, in the first signal processing device as an embodiment, in the polarization sensor, a polarization pixel unit is formed by two-dimensionally arranging, in a predetermined pattern, four types of pixels that receive light having polarization angles that differ by 45 degrees.

As a result, when a polarization image is to be generated, fitting of the sine wave indicating the polarization state can be performed on the basis of the sample value of the polarization angle in increments of 45 degrees, which is a necessary and sufficient sample value.

Thus, the polarization state of incident light can be appropriately estimated, and a polarization image can be appropriately generated.

Furthermore, a second signal processing device as an embodiment includes: a polarization sensor in which polarization pixel units formed by two-dimensionally arranging a plurality of types of pixels that selectively receive light of different polarization angles in a predetermined pattern are two-dimensionally arranged; an image organizing unit that receives an input of a captured image obtained by the polarization sensor, extracts the light reception values of pixels that receive light of the same polarization angles from the captured image, and organizes polarization-angle-specific images that are images for the respective polarization angles; and a signal processing unit that performs signal processing on the polarization-angle-specific images obtained by the image organizing unit.

With such a second signal processing device, it is possible to achieve functions and effects similar to those of the first signal processing device described above.

Note that the effects described in the present specification are merely examples and are not restrictive, and some other effects may also be provided.

### 5. Present Technology

Note that the present technology can also have the following configurations.

(1) A signal processing device including:
an image organizing unit that receives an input of a captured image obtained by a polarization sensor, and extracts a light reception value of pixels that receive light of the same polarization angle from the captured image to organize polarization-angle-specific images that are images for respective polarization angles, the polarization sensor having polarization pixel units formed by two-dimensionally arranging a plurality of types of pixels that selectively receive light of different polarization angles in a predetermined pattern, the polarization pixel units being two-dimensionally arranged in the polarization sensor; and
a signal processing unit that performs signal processing on the polarization-angle-specific images obtained by the image organizing unit.
   (2)

The signal processing device according to (1), in which
the image organizing unit
outputs the polarization-angle-specific images for the respective polarization angles in a time-division manner within one frame period.
   (3)

The signal processing device according to (2), in which
the signal processing unit
performs signal processing on the polarization-angle-specific images for the respective polarization angles, in order of outputs from the image organizing unit.
   (4)

The signal processing device according to any one of (1) to (3), in which
the signal processing unit
performs a pixel position correction process that is a process of correcting pixel positions of the respective polarization angles that are different positions in the captured image, to the same pixel position.
   (5)

The signal processing device according to (4), in which
the signal processing unit
performs, as signal processing on the polarization-angle-specific images, the pixel position correction process and a lens distortion correction process as a common filtering process.
   (6)

The signal processing device according to any one of (1) to (5), further including:
a polarization image generation unit that generates a polarization image; and
a timing adjustment unit that performs control to input the polarization-angle-specific images subjected to the signal processing by the signal processing unit, to the polarization image generation unit in a frame-synchronized manner.
   (7)

The signal processing device according to any one of (1) to (6), in which
the image organizing unit
receives an input of a captured image obtained by the polarization sensor in which color polarization pixel units are two-dimensionally arranged, the color polarization pixel units being formed by two-dimensionally arranging, in a predetermined pattern, a plurality of types of the polarization pixel units each of which receives light of a different color, and extracts a light reception value of pixels that receive light of the same polarization angle from the captured image, to organize the polarization-angle-specific images.
   (8) The signal processing device according to (7), in which,
in the polarization sensor, the color polarization pixel units each include the polarization pixel unit that selectively receives red light, the polarization pixel unit that selectively receives green light, and the polarization pixel unit that selectively receives blue light, the polarization pixel units being arranged in a Bayer pattern.
   (9)

The signal processing device according to any one of (1) to (8), in which,
in the polarization sensor, the polarization pixel unit includes four types of pixels that receive light of polarization angles that differ by 45 degrees from each other, the four types of pixels being two-dimensionally arranged in a predetermined pattern.
   (10)

A signal processing device including:
a polarization sensor in which polarization pixel units formed by two-dimensionally arranging a plurality of types of pixels that selectively receive light of different polarization angles in a predetermined pattern are two-dimensionally arranged;
an image organizing unit that receives an input of a captured image obtained by the polarization sensor, and extracts a light reception value of pixels that receive light of the same polarization angle from the captured image to organize polarization-angle-specific images that are images for the respective polarization angles; and
a signal processing unit that performs signal processing on the polarization-angle-specific images obtained by the image organizing unit.
   (11)

A program that is readable by a computer device, and causes the computer device to execute a function of:
receiving an input of a captured image obtained by a polarization sensor in which polarization pixel units formed by two-dimensionally arranging a plurality of types of pixels selectively receiving light of different polarization angles in a predetermined pattern are two-dimensionally arranged; extracting a light reception value of pixels receiving light of the same polarization angle from the captured image to organize polarization-angle-specific images that are images for the respective polarization angles; and performing signal processing on the polarization-angle-specific images.

### REFERENCE SIGNS LIST

1, 1A, 1B Signal processing device
2, 2A Polarization sensor
2a, 2Aa Pixel array unit
3 Image organizing unit
4 Preprocessing unit
5 Distortion correction unit
6 Timing adjustment unit
7 Polarization image generation unit
8 Memory unit
9 Bus
10 Demosaicing unit
11 Signal processing unit
Px Pixel
PP Polarization pixel unit
PC Color polarization pixel unit
50 Semiconductor layer
51 Wiring layer
52 Polarizing filter
53 Microlens
54 Color filter

1. A signal processing device comprising:
an image organizing unit that receives an input of a captured image obtained by a polarization sensor, and extracts a light reception value of pixels that receive light of the same polarization angle from the captured image to organize polarization-angle-specific images that are images for respective polarization angles, the polarization sensor having polarization pixel units formed by two-dimensionally arranging a plurality of types of pixels that selectively receive light of different polarization angles in a predetermined pattern, the polarization pixel units being two-dimensionally arranged in the polarization sensor; and
a signal processing unit that performs signal processing on the polarization-angle-specific images obtained by the image organizing unit.

2. The signal processing device according to claim 1, wherein
the image organizing unit
outputs the polarization-angle-specific images for the respective polarization angles in a time-division manner within one frame period.

3. The signal processing device according to claim 2, wherein
the signal processing unit
performs signal processing on the polarization-angle-specific images for the respective polarization angles, in order of outputs from the image organizing unit.

4. The signal processing device according to claim 1, wherein
the signal processing unit
performs a pixel position correction process that is a process of correcting pixel positions of the respective polarization angles that are different positions in the captured image, to the same pixel position.

5. The signal processing device according to claim 4, wherein
the signal processing unit
performs, as signal processing on the polarization-angle-specific images, the pixel position correction process and a lens distortion correction process as a common filtering process.

6. The signal processing device according to claim 1, further comprising:
a polarization image generation unit that generates a polarization image; and
a timing adjustment unit that performs control to input the polarization-angle-specific images subjected to the signal processing by the signal processing unit, to the polarization image generation unit in a frame-synchronized manner.

7. The signal processing device according to claim 1, wherein
the image organizing unit
receives an input of a captured image obtained by the polarization sensor in which color polarization pixel units are two-dimensionally arranged, the color polarization pixel units being formed by two-dimensionally arranging, in a predetermined pattern, a plurality of types of the polarization pixel units each of which receives light of a different color, and extracts a light reception value of pixels that receive light of the same polarization angle from the captured image, to organize the polarization-angle-specific images.

8. The signal processing device according to claim 7, wherein,
in the polarization sensor, the color polarization pixel units each include the polarization pixel unit that selectively receives red light, the polarization pixel unit that selectively receives green light, and the polarization pixel unit that selectively receives blue light, the polarization pixel units being arranged in a Bayer pattern.

9. The signal processing device according to claim 1, wherein,
in the polarization sensor, the polarization pixel unit includes four types of pixels that receive light of polarization angles that differ by 45 degrees from each other, the four types of pixels being two-dimensionally arranged in a predetermined pattern.

10. A signal processing device comprising:
a polarization sensor in which polarization pixel units formed by two-dimensionally arranging a plurality of types of pixels that selectively receive light of different polarization angles in a predetermined pattern are two-dimensionally arranged;
an image organizing unit that receives an input of a captured image obtained by the polarization sensor, and extracts a light reception value of pixels that receive light of the same polarization angle from the captured image to organize polarization-angle-specific images that are images for the respective polarization angles; and
a signal processing unit that performs signal processing on the polarization-angle-specific images obtained by the image organizing unit.

11. A program that is readable by a computer device, and causes the computer device to execute a function of:
receiving an input of a captured image obtained by a polarization sensor in which polarization pixel units formed by two-dimensionally arranging a plurality of types of pixels selectively receiving light of different polarization angles in a predetermined pattern are two-dimensionally arranged; extracting a light reception value of pixels receiving light of the same polarization angle from the captured image to organize polarization-angle-specific images that are images for the respective polarization angles; and performing signal processing on the polarisation-angle-specific images.
